(19) United States
(12) Patent Application Publication
(10) Pub. No.: US 2025/0180779 A1
(43) Pub. Date: Jun. 5, 2025

(54) MEASUREMENT-CORRECTED WIND PROFILE FOR INCREASED ACCURACY OF WIND FLOW FIELD

(71) Applicant: SeekOps Inc., Austin, TX (US)

(72) Inventors: Travis R. Eckert, Austin, TX (US); Brendan James Smith, Lakeway, TX (US); Abigail M. Corbett, Pfluggerville, TX (US); Kyle W. Dawson, Austin, TX (US)

(21) Appl. No.: 18/840,621

(22) PCT Filed: Feb. 24, 2023
(86) PCT No.: PCT/US23/13893

§ 371 Date: Aug. 22, 2024

Related U.S. Application Data
(60) Provisional application No. 63/313,873, filed on Feb. 25, 2022.

(51) Int. Cl. G01W 1/04; G01W 1/08; G01W 1/10

(52) U.S. Cl. CPC G01W 1/04; G01W 1/08; G01W 1/10

(57) ABSTRACT

Systems, devices, and methods for generating a first wind model, wherein the first wind model is based on at least one or more key parameters; generating a second wind model, wherein the second wind model is based on a secondary wind measurement device, from at least one of: a second stationary anemometer, an aerial-based data from an onboard anemometer, a control-system derived wind vector during a flight of an unmanned aerial vehicle, and a third-party meteorological data service; adjusting the second wind model based on a comparison of two or more altitudes; and adjusting the one or more key parameters to achieve a solution convergence, where the solution convergence is achieved when at least one of: a determined error between a received wind data and the second wind model is minimized to within an accepted tolerance range and a number of minimization attempts exceeds a threshold.

### CROSS-REFERENCE TO RELATED APPLICATIONS

This application is a 35 U.S.C § 371 National Stage Entry of International Application No. PCT/US2023/013893, filed Feb. 24, 2023, which claims the priority benefit of U.S. Provisional Patent Application Ser. No. 63/313,873 filed Feb. 25, 2022, all of which are hereby incorporated herein by reference in their entireties for all purposes.

### FIELD OF ENDEAVOR

The invention relates to trace gas emissions, and more particularly to detecting and quantifying trace gas emissions.

### BACKGROUND

Methane (CH4) is an odorless and colorless trace gas including naturally occurring organic molecules, present in the atmosphere at average ambient levels of approximately 1.85 ppm as of 2018, and is projected to continually increase in quantity. While methane is found globally in the atmosphere, a significant amount is collected or “produced” through anthropogenic processes including exploration, extraction, and distribution of petroleum in the form of natural gas. Natural gas, an odorless and colorless gas, is a primary source of energy used to produce electricity and heat. The main component of natural gas is methane (93.9 mol % CH4 typ.). While extraction of natural gas is a large source of methane released to atmosphere, major contributors of methane also include livestock farming (enteric fermentation), and solid waste and wastewater treatment (anaerobic digestion).

### SUMMARY

Embodiments disclosed herein include systems and methods comprising components and processes configured to adjust parameters in a wind model to account for differences between actual wind measurements throughout at least portions of the atmosphere, and modelled wind speeds when an unmanned aerial vehicle (UAV) with a trace gas sensor is positioned within the atmosphere. A method and system embodiment disclosed herein may improve the accuracy of a wind model through iteration and error minimization, such as for trace gas sensing applications. The method embodiment may further include generating a first wind model, wherein the first wind model is based on at least one or more key parameters (e.g., a surface roughness value, stability classification scalar, etc.); generating a second wind model, wherein the second wind model is based on a secondary wind measurement such as from either a second stationary anemometer, aerial-based data from an onboard anemometer or control-system derived wind vector during a flight of the UAV, or a third party meteorological data service; adjusting the second wind model based on a comparison of two or more altitudes; and adjusting the parameters to reduce or preferably minimize a difference between solutions (e.g., by solution convergence) the second wind model so the solution at both heights match the two independent measured values.

Additional method and system embodiments may include: determining a presence of one or more trace gases using the determined wind model, quantifying the presence of trace gases using the determined wind model, or using multiple UAV-based wind measurements to determine a flow field such as anemometer on UAV. In additional method embodiments, the UAV-based data is derived from UAV model estimation or from control input response comprising one or more of: a throttle response, a pitch, a roll, and a yaw. In additional method embodiments, the two or more altitudes comprise one or more of: a real anemometer altitude, an altitude where highest concentrations of trace gas are measured, a building height, and an estimated building height.

Additional method and system embodiments may include: determining a presence of one or more trace gases using the determined wind model, quantifying the presence of trace gases using the determined wind model, or using multiple anemometers to determine a flow field.

Additional method and system embodiments may include: determining a presence of one or more trace gases using the determined wind model, quantifying the presence of trace gases using the determined wind model, or using any combination of anemometers, UAV-based wind, and third-party weather service to determine a flow field.

A method embodiment may include: generating a first wind model, where the first wind model is based on at least one or more key parameters; generating a second wind model, where the second wind model is based on a secondary wind measurement device, from at least one of: a second stationary anemometer, an aerial-based data from an onboard anemometer, a control-system derived wind vector during a flight of an unmanned aerial vehicle (UAV), and a third-party meteorological data service; adjusting the second wind model based on a comparison of two or more altitudes; and adjusting the one or more key parameters to achieve a solution convergence, where the solution convergence is achieved when at least one of: a determined error between a received wind data and the second wind model is minimized to within an accepted tolerance range and a number of minimization attempts exceeds a threshold.

In additional method embodiments, the one or more key parameters comprise a surface roughness value. In additional method embodiments, the one or more key parameters comprise a stability value. In additional method embodiments, the one or more key parameters comprise a displacement height value.

Additional method embodiments may further include: determining a presence of one or more trace gases using a determined wind model. Additional method embodiments may further include: quantifying the presence of the one or more trace gases using a determined wind model. Additional method embodiments may further include: determining a flow field using two or more UAV-based wind measurements.

In additional method embodiments, a UAV-based data comprises one or more of: a throttle response, a pitch, a roll, and a yaw. In additional method embodiments, the two or more altitudes comprise one or more of: a real anemometer altitude, an altitude where highest concentrations of trace gas are measured, a building height, and an estimated building height.

In additional method embodiments, the two or more altitudes comprise one or more of: a real anemometer altitude, an altitude where a highest concentration of trace gas is measured, a building height, an estimated building height, and a displacement height. In additional method embodiments, the determined error between the received wind data and the second wind model is a least square residual error.

A system embodiment may include: a first stationary anemometer configured to generate wind data; a second stationary anemometer configured to generate wind data; a third-party meteorological data service configured to provide wind data; an unmanned aerial vehicle (UAV), where the UAV comprises one or more of: a control system, a global positioning sensor (GPS), a trace gas sensor, a LIDAR sensor, a barometer sensor, a thermistor sensor, and an anemometer; a processor in communication with one or more of: the first stationary anemometer, the second stationary anemometer, the third-party meteorological data service, and the unmanned aerial vehicle (UAV), where the processor is configured to: determine, by an initial parameter component, an initial parameter guess; determine, by a first wind data component, a first wind data from at least one of: the first stationary anemometer and the third-party meteorological data service; generate, by a first wind model component, a first wind model based on the determined initial parameter component and the determined first wind data; determine, by a second wind data component, a second wind data from at least one of: the second stationary anemometer, anemometer, and the third-party meteorological data service; process, by an optimizing algorithm component, the generated first wind model via an optimizing algorithm; generate, by a second wind model component, a second wind model based on one or more of: the optimizing algorithm and the first wind data; generate, by the concentration and position data component, a trace gas data from data from the trace gas sensor and the GPS of the UAV; and determine, by the flux calculation component, an elevated trace gas concentration based on the generated trace gas data and the second wind model.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a diagram of primary surface level sublayers in an atmospheric boundary layer, according to one embodiment;

FIG. 2 depicts a high-level flowchart of a method embodiment for correcting wind data, according to one embodiment;

FIG. 3 depicts a comparison of surface anemometer windspeeds extrapolated to drone height by an optimization of surface roughness height against a Kalman filter drone windspeed and an adjusted windspeed as a function of altitude, according to one embodiment;

FIG. 4 depicts a system for correcting a wind profile, according to one embodiment;

FIG. 5A depicts a high-level block diagram of a system for correcting wind data, according to one embodiment;

FIG. 5B depicts a high-level block diagram of an alternate system for correcting wind data, according to one embodiment;

FIG. 5C depicts a high-level block diagram of another alternate system for correcting wind data, according to one embodiment;

FIG. 6 depicts a table of processed and reprocessed results for trace gas using the disclosed method, according to one embodiment;

FIG. 7 illustrates an example top-level functional block diagram of a computing device embodiment;

FIG. 8 shows a high-level block diagram and process of a computing system for implementing an embodiment of the system and process;

FIG. 9 shows a block diagram and process of an exemplary system in which an embodiment may be implemented;

FIG. 10 depicts a cloud computing environment for implementing an embodiment of the system and process disclosed herein; and

FIG. 11 depicts a system for detecting trace gases, according to one embodiment.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

Embodiments disclosed herein include systems and methods comprising components and processes configured to adjust parameters in a wind model to account for differences between actual wind measurements throughout at least portions of the atmosphere, and modelled wind speeds when an unmanned aerial vehicle (UAV) with a trace gas sensor is positioned within the atmosphere. This method is aptly suited for geometrically complex environments, e.g., when measurements are gathered directly downwind of a building or other large structures, but the method is applicable to improve any wind model regardless of infrastructure in the immediate environment. A wind sensor or anemometer on the UAV may be reading an unobstructed wind at a height, such as about 2 m. However, the wind may be moving at a far higher or lower speed than that of the wind the UAV is measuring via the wind sensor or anemometer.

A method embodiment may include: generating a first wind model, where the first wind model is based on at least one or more key parameters; generating a second wind model, where the second wind model is based on a secondary wind measurement device, from at least one of: a second stationary anemometer, an aerial-based data from an onboard anemometer, a control-system derived wind vector during a flight of a UAV, and a third-party meteorological data service; adjusting the second wind model based on a comparison of two or more altitudes; and adjusting the one or more key parameters to minimize the difference between solutions (solution convergence) of the second wind model so that the solution at both heights essentially matches two independent measured values.

In one embodiment, said two independent measured values refer to the measured values from a stationary anemometer and a wind value from a UAV (e.g., drone). Said two independent measured values may also be considered two discrete wind measurements at different altitudes. In one embodiment, said solutions refer to the surface roughness value, stability classification scalar, etc. that may be optimized for, and are used to put back into the wind model.

Another method embodiment may include: generating a first wind model, where the first wind model is based on at least one or more key parameters; generating a second wind model, where the second wind model is based on a secondary wind measurement device, from at least one of: a second stationary anemometer, an aerial-based data from an onboard anemometer, a control-system derived wind vector during a flight of a UAV, and a third-party meteorological data service; adjusting the second wind model based on a comparison of two or more altitudes; and adjusting the one or more key parameters to achieve a solution convergence, where the solution convergence is achieved when at least one of: a determined error between a received wind data and the second wind model is minimized to within an accepted tolerance range and a number of minimization attempts exceeds a threshold.

In additional method embodiments, the one or more key parameters comprise a surface roughness value. In additional method embodiments, the one or more key parameters comprise a stability value. In additional method embodiments, the one or more key parameters comprise a displacement height value. Additional method embodiments may further include: determining a presence of one or more trace gases using a determined wind model. Additional method embodiments may further include: quantifying the presence of the one or more trace gases using a determined wind model. Additional method embodiments may further include: determining a flow field using two or more UAV-based wind measurements. In additional method embodiments, a UAV-based data comprises one or more of: a throttle response, a pitch, a roll, and a yaw. In additional method embodiments, the two or more altitudes comprise one or more of: a real anemometer altitude, an altitude where highest concentrations of trace gas are measured, a building height, and an estimated building height.

A system embodiment may include: a first generator component configured to generate a first wind model, wherein the first wind model is based on at least one or more key parameters; a second generator component configured to generate a second wind model, wherein the second wind model is based on a secondary wind measurement device, from at least one of: a second stationary anemometer, an aerial-based data from an onboard anemometer, a control-system derived wind vector during a flight of a UAV, and a third-party meteorological data service; an adjuster component configured to: adjust the second wind model based on a comparison of two or more altitudes, and adjust the one or more key parameters to minimize a difference between the solutions (solution convergence) of the second wind model so the solution at both heights match the two independent measured values.

Another system embodiment may include: a first stationary anemometer component configured to generate wind data; a second stationary anemometer component configured to generate wind data; a third-party meteorological data service component configured to provide wind data; an unmanned aerial vehicle (UAV), where the UAV comprises one or more of: a control system, a global positioning sensor (GPS), a trace gas sensor, a LIDAR sensor, a barometer sensor, a thermistor sensor, and an anemometer; a processor in communication with one or more of: the first stationary anemometer, the second stationary anemometer, the third-party meteorological data service, and the unmanned aerial vehicle (UAV), where the processor is configured to: determine, by an initial parameter component, an initial parameter guess; determine, by a first wind data component, a first wind data from at least one of: the first stationary anemometer and the third-party meteorological data service; generate, by a first wind model component, a first wind model based on the determined initial parameter component and the determined first wind data; determine, by a second wind data component, a second wind data from at least one of: the second stationary anemometer, anemometer, and the third-party meteorological data service; process, by an optimizing algorithm component, the generated first wind model via an optimizing algorithm; generate, by a second wind model component, a second wind model based on one or more of: an optimizing algorithm and the first wind data; generate, by the concentration and position data component, a trace gas data from the trace gas sensor and the GPS of the UAV; and determine, by the flux a calculation component, an elevated trace gas concentration based on the generated trace gas data and the second wind model.

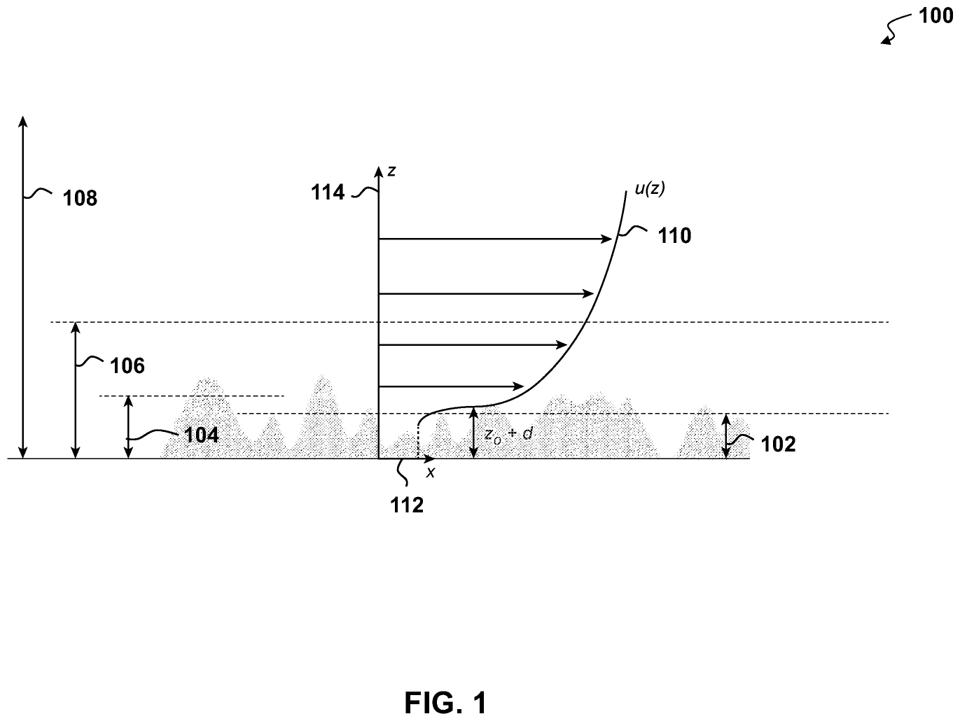

FIG. 1 depicts a diagram of primary surface level sublayers in an atmospheric boundary layer 100. The atmospheric boundary layer 100 is a bottom layer of the troposphere that is in contact with the surface of the earth. The atmospheric boundary layer 100 may include an average obstruction height 102, a canopy sublayer 104, a roughness sublayer 106, and an atmospheric surface layer 108. The average obstruction height 102 may be shorter than a height of the canopy sublayer 104. The average obstruction height 102 is an average height of obstructions in the environment. The average obstruction height 102 is related to the displacement height d in Eq. (1). The atmospheric sublayer 108 may have a height between 100 m and 300 m. A wind velocity profile u(z) 110 shows the change in horizontal wind speed as a function of altitude above ground level. The wind velocity profile u(z) 110 shows that the wind speed 112 typically increases as the altitude 114 increases. A widely accepted wind model based in well-established similarity theory, the Log Wind Profile for neutrally stable conditions, assumes that wind speed typically increases as the altitude increases as seen in Eq. (1), and that the relationship between windspeed and altitude is logarithmic. Eq. (1) is as follows.

$$u ( z ) = \frac{{u}_{*}}{κ} [ ln ( \frac{z - d}{{z}_{0}} ) + ψ ( z , {z}_{0} , L ) ]$$

In Eq. (1), u, is the friction velocity, K is the von-karman constant, dis the height above the displacement plane at which the mean wind tends towards zero, and z₀ is the surface roughness height. In embodiments that allow for the estimation of atmospheric stability, a stability term y can be calculated as a function of the Monin-Obukhov Length L. From here we continue for neutrally stable conditions, thus this stability term is zero and so it vanishes. Given anemometer measurements at the surface altitude are available, estimating the wind speed at a higher altitude u(z₂) can be achieved under the assumption that the ratio u_{*}/K and the surface roughness parameter z₀ and displacement height d remain constant at both altitudes. This rearranging results in a single unknown for u(z₂) and is shown in Eq. (2). Eq. (2) is as follows:

$$\frac{{u}_{*}}{κ} = \frac{u ( {z}_{2} )}{ln ( ( {z}_{2} - d ) / {z}_{0} )} = \frac{u ( {z}_{1} )}{ln ( ( {z}_{1} - d ) / {z}_{0} )}$$

We then rearrange Eq. (2) to solve for the desired windspeed at altitude u(z₂) as shown in Eq. (3).

Eq. (3) is as follows.

$$u ( {z}_{2} ) = u ( {z}_{1} ) \frac{ln ( ( {z}_{2} - d ) / {z}_{0} )}{ln ( ( {z}_{1} - d ) / {z}_{0} )}$$

In some embodiments, the wind sensor or anemometer may be stationary. In other embodiments, the wind sensor or anemometer may be on another UAV or drone. The measurement at altitude when from an anemometer device may render this process unnecessary. The wind sensor or anemometer on another UAV or drone may be used when the wind measurement is from a control system output. In other embodiments, the wind sensors or anemometers may be stationary, mobile, or some combination and auxiliary wind data at desired altitudes may be acquired as a constraint to the estimation of an appropriate surface roughness parameter z₀.

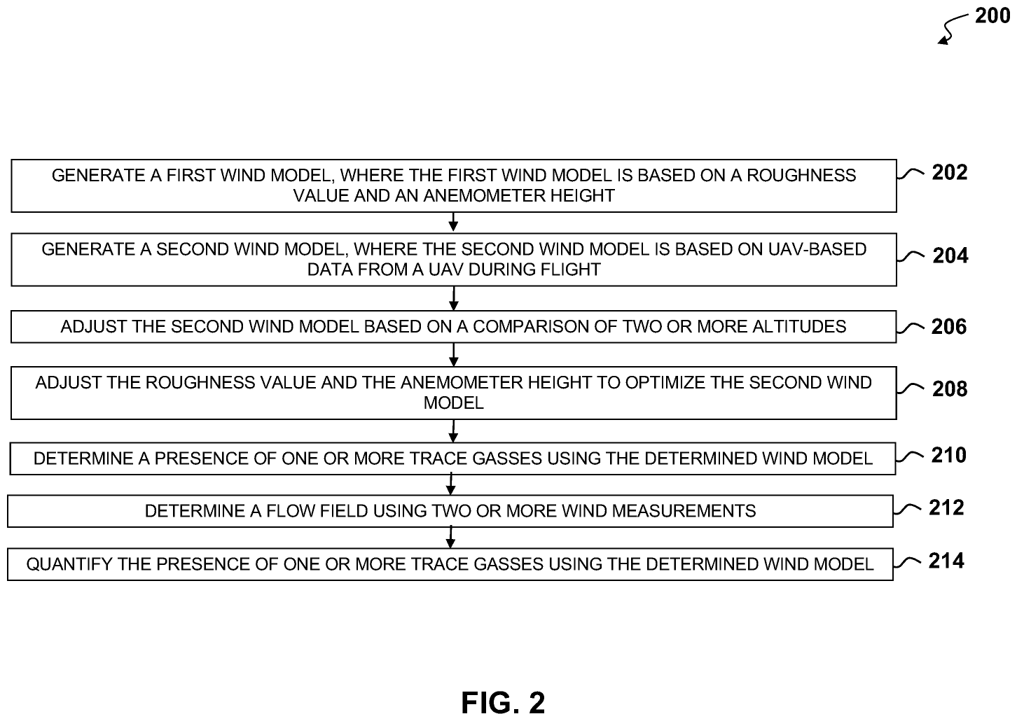

FIG. 2 depicts a high-level flowchart of a method or process embodiment 200 for improving and preferably optimizing wind data quality, according to one embodiment. The method 200 may include generating a first wind model, where the first wind model is based on at least one or more key parameters (e.g., a roughness value and an anemometer height) (step 202). The roughness, or roughness length, value is a parameter to account for surface roughness in the log profile model and is determined through a look-up table of commonly accepted characterized roughness length values. The anemometer height, if stationary, is fixed and can be either predefined or measured from the ground surface directly below the point of wind measurement on the device. In a mobile implementation, the height will be measured above ground level. The wind model may be run with first guess parameters, with an appropriate roughness value and anemometer height (e.g., 2 m) to generate the first wind estimates expected at the location z₂. In some embodiments, the second wind speed may be from another stationary wind sensor or anemometer. In some embodiments, the second wind speed may be from a non-stationary wind sensor, such as an accurate UAV-mounted wind sensor. The use of UAV control system wind speed estimates is a data-informed constraint on the minimization technique of the wind model parameter determination. These data serve as the u2 measurements to fit the surface u1 measurements to.

The method 200 may then include generating a second wind model, where the second wind model is based on a secondary wind measurement device during a flight of an aircraft such as a UAV (step 204). The second wind model may be based on a secondary wind measurement device. The secondary wind measurement device may be a second stationary anemometer or an aerial-based data from at least one of: an onboard anemometer and a control-system derived wind vector during the flight of the UAV. The UAV-based data may include a throttle response, a pitch, a roll, and a yaw, and the like. The state of the aircraft, as determined by the onboard inertial measurement unit (IMU) and GPS, is influenced by another state parameter which may be the wind speed. An onboard control system of the aircraft generates an estimate of this wind speed, e.g., using Kalman filter estimations of the state variables such that a data-informed constraint can be applied to the determination of the surface roughness parameter in the second wind model. The system and method disclosed herein may process the UAV-based data to create the altitude-based wind model experienced by the UAV during the flight of the UAV. The first wind model is refined based on the UAV/drone data.

The method 200 may then include adjusting the second wind model based on a comparison of two or more altitudes (step 206). The two or more altitudes may include a real anemometer altitude, an altitude where highest concentrations of trace gas are measured, a building height, and an estimated building height. The disclosed system and method may compare three particular altitudes on the altitude-based log wind profile for adjustments. A first altitude may be at real anemometer height, e.g., about 2 m. A second altitude may be at the altitudes where highest concentrations of trace gas or methane are seen. A third altitude may be at building height, estimated building height or displacement height.

The method 200 may then include adjusting the one or more key parameters, e.g., roughness value and the anemometer height, to converge the second wind model so the solution at both heights matches the two independent measured values (step 208). Solution convergence is the condition for which the difference between the observations and the model solution is minimized. In some embodiments, the one or more key parameters may be adjusted manually. For manual adjustment, the adjusting is complete and solution convergence is achieved when the user determines a visual match between the model and the flight log wind data. In other embodiments, the one or more key parameters may be automatically determined by a processor. For adjustment by a processor, the adjusting is complete and solution convergence is achieved when the least square residual error between onboard wind data and the processor-generated model is minimized to within the accepted tolerance range or the number of minimization attempts exceeds a threshold. In the latter, the solution is still used, even if the error is outside the tolerance range. In other embodiments, the error may be evaluated in other ways besides the least square residual. The wind data may be onboard wind, another stationary anemometer, or third-party weather data. The disclosed system and method may use input parameters “displacement height”, “surface roughness”, or “stability” to best match the windspeed model to that seen by the drone and normal to the survey flight paths. The surface roughness, displacement height, and/or stability may be manually tuned in some embodiments. In other embodiments, an optimization function and/or a goal seeking function may be applied to the surface roughness, displacement height, and/or stability variables. In some embodiments, the anemometer height may be a wind sensor height. In cases when where the models did not match well, the disclosed system and method may use either the second altitude or the third altitude noted above to best estimate the wind values that are most important to the user.

In embodiments that include a ground-based anemometer and Kalman-filter resolved wind speed state variable, the optimization is performed on the timeseries of data generated at the ground and at-altitude to arrive at the optimal solution of the surface roughness parameter z₀. The vector representation of the fitting procedure is shown in Eq. (4).

Eq. (4) is as follows:

$$Let \vec{u} = [ \begin{matrix}u ( {z}_{a} , {t}_{0} ) \\ … \\ u ( {z}_{a} , {t}_{n} )\end{matrix} ] ;$$

$$\vec{z} = [ \begin{matrix}z ( {t}_{0} ) \\ … \\ z ( {t}_{n} )\end{matrix} ] ;$$

$$and$$

$$\vec{y} = [ \begin{matrix}u ( z , {t}_{0} ) \\ … \\ u ( z , {t}_{n} )\end{matrix} ] .$$

The surface roughness parameter z₀ is then optimized by fitting the following equation: \vec{y}=f(\vec{u},\vec{z},z₀) where f is Eq. (3) and dis assumed to be zero. In some embodiments where building obstructions may be present, d may be determined simultaneously with z₀ as a secondary fit parameter. Above, zₐ is the ground-based anemometer height and t indicates the time of the measurement. Here, one value of z₀ is optimized and constrained by the time-varying wind speeds at the ground and at UAV altitudes z(t) estimated by the Kalman filter solution.

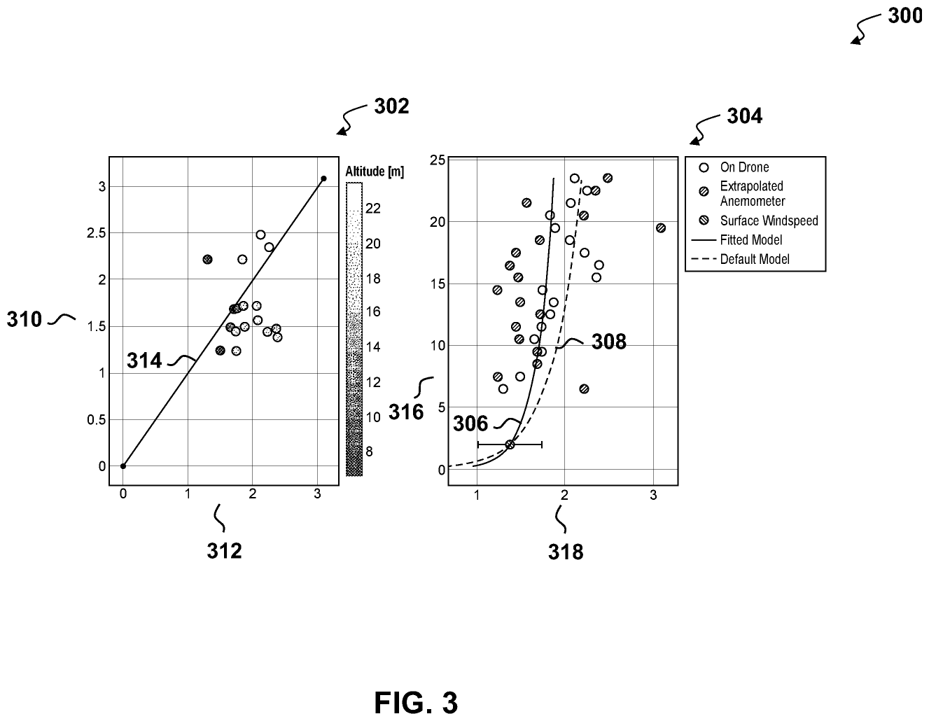

FIG. 3 depicts the result of an optimization procedure. Specifically, FIG. 3 illustrates a graph 302 comparing anemometer-to-UAV windspeed measurements. The graph 302 depicts a 1:1 comparison of surface anemometer windspeeds extrapolated to drone height by the optimization of surface roughness height against the Kalman filter drone windspeed. FIG. 2 further illustrates a graph 304 that depicts model fit results. The graph 304 depicts an adjusted windspeed as a function of altitude with the resulting model used to retrieve the emission estimate 306 compared with a default model 308. FIG. 3 depicts a 1:1 comparison of surface anemometer windspeeds 300 extrapolated to drone height by the optimization of surface roughness height against the Kalman filter drone windspeed and the adjusted windspeed as a function of altitude with the resulting fitted model 306 used to retrieve the emission estimate compared with a default model 308 where z₀=0.03. The Kalman filter drone windspeed depicts a windspeed extrapolated from an anemometer as measured in m/s 310 on the y-axis and a windspeed on the drone in m/s 312 on the x-axis. The fitted model 314 of the Kalman filter drone windspeed 302 is linear. The adjusted windspeed as a function of altitude 304 depicts an altitude in meters 316 on the y-axis and a windspeed in m/s 318 on the x-axis. The fitted model 306 and default model 308 are exponential. The fitted model 306 more accurately aligns with the emission estimate as compared to the default model 308.

Referring back to FIG. 2, the method 200 may further include determining a presence of one or more trace gases using the determined wind model (step 210). In some embodiments, the two wind measurements may be in the same vicinity of each other, e.g., 500 m from each other, irrespective of wind direction.

The method 200 may then include determining a flow field using two or more UAV-based wind measurements (step 212) and/or quantifying the presence of the one or more trace gases using the determined wind model (step 214). In additional embodiments, a third-party weather data source may be used to improve the model parameters. In one embodiment, the third-party weather data source may include a high-resolution surface wind speed grid from synthetic means or a sensor-based grid.

Trace gas emissions may be measured via a trace gas sensor and a wind sensor. The trace gas sensor and the wind sensor may be located on a UAV. In some embodiments, the wind sensor may be located distal from the UAV and the wind speed may be extrapolated based on an altitude of the UAV. An aerodynamic model for the UAV may be used to estimate wind speed at varying altitudes.

In some embodiments, a log wind profile may be compromised due to wind sensor or anemometer placement. The log wind profile is a parameterization of wind speed as a function of altitude up to the boundary layer height, but it is only derived for neutrally stable conditions. In cases when the boundary layer is not neutrally stable, which may occur often, the log wind profile may not be the correct model to use and may require a stability term as determined from 3D wind measurements. The disclosed system and method, in one embodiment, allow for a tuning of the parameters: a roughness value and an anemometer altitude. By varying these inputs, the disclosed system and method can better match the wind profile utilized by the aerodynamic model to that interpreted as being experienced by the UAV where trace gas is being measured.

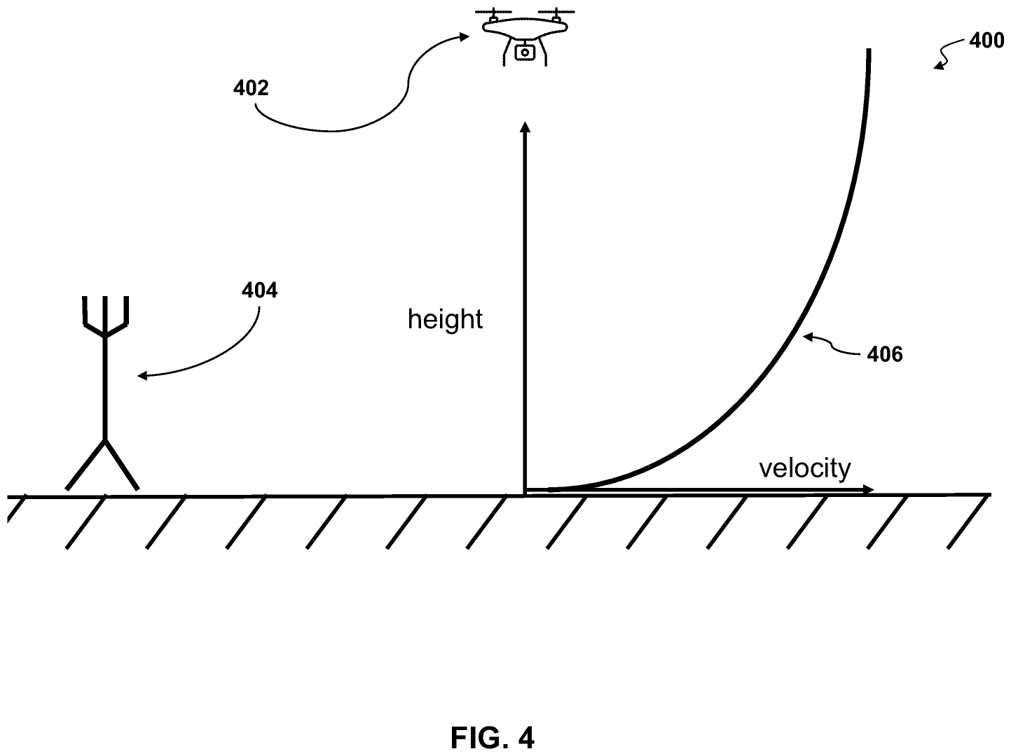

FIG. 4 depicts a system 400 for correcting a wind profile. The system 400 may include a drone 402 such as a UAV and a stationary wind measurement device 404 such as an anemometer. Wind measured on the drone 402 can be compared to wind measured on the stationary wind measurement device 404 to determine a wind velocity profile 406.

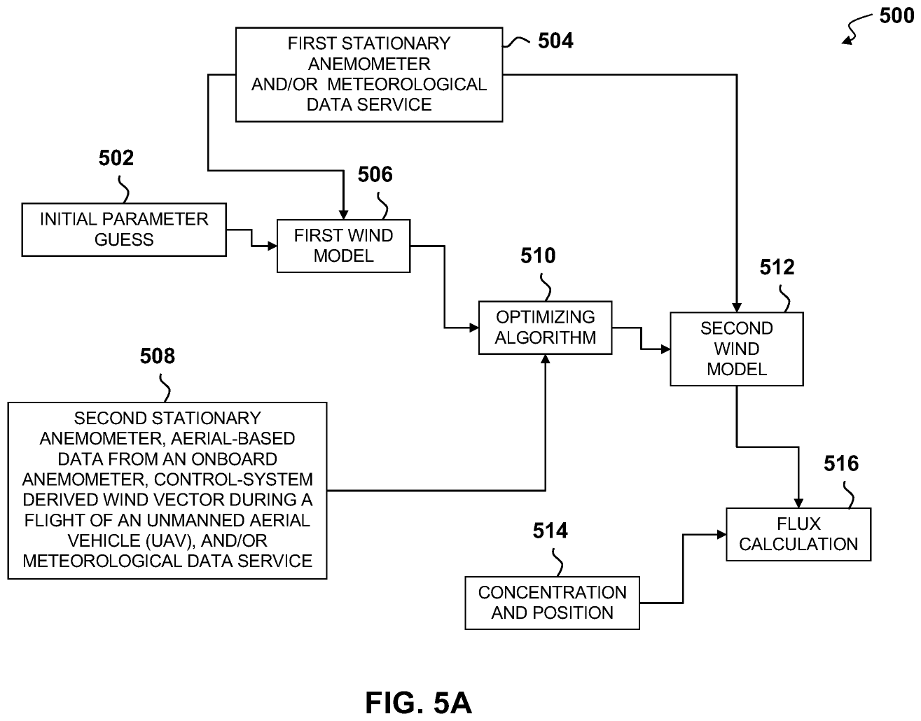

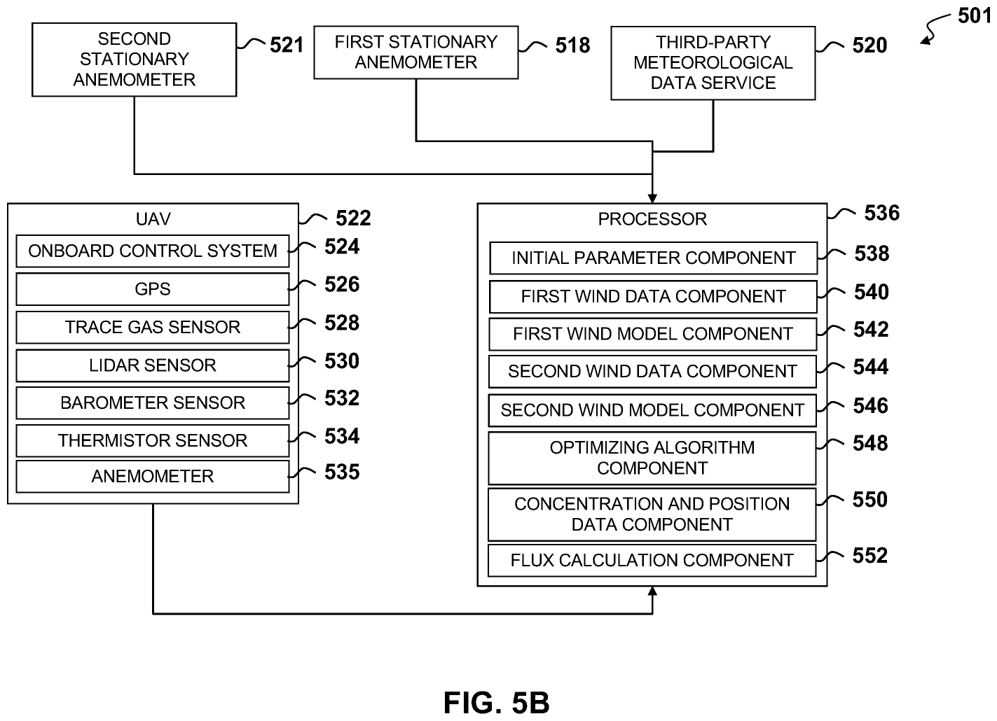

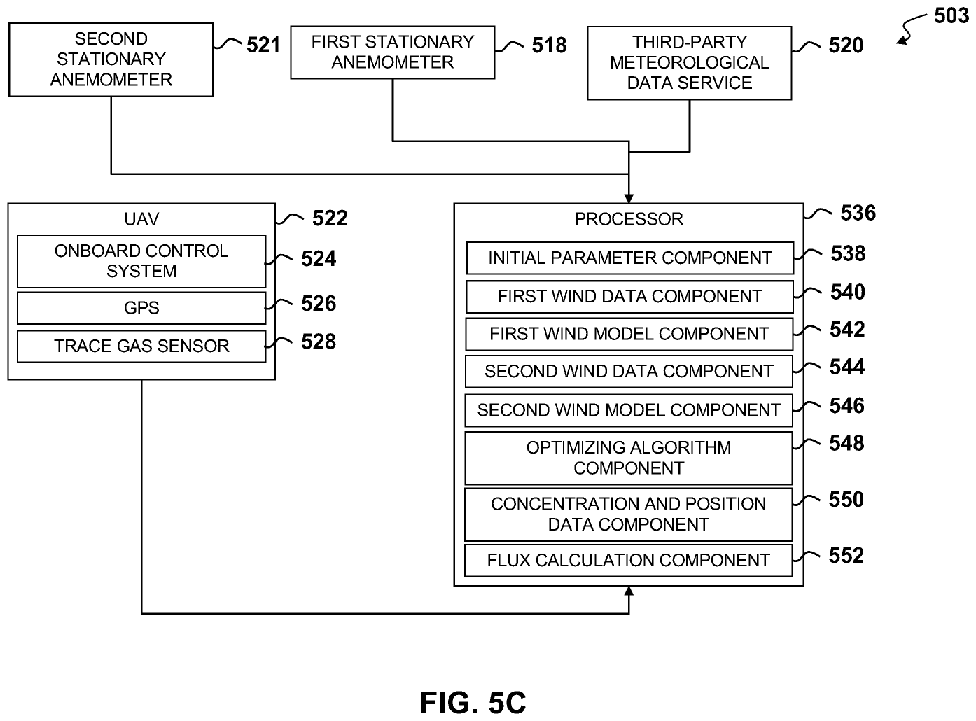

FIG. 5A depicts a high-level block diagram of a system 500 for correcting wind data, according to one embodiment. Components described herein may comprise hardware, electronics, processors, software, or a combination of one or more thereof. Wind data is gathered from two sources. The surface anemometer collects wind speed and direction data at a fixed location. The control system onboard the UAV reports wind speed and average direction. The best-fit wind profile is determined in post-processing.

The UAV altitude is determined in three forms. A first way altitude is determined is from a GPS sensor onboard the UAV. A second way altitude is determined is by a LiDAR sensor mounted on the trace gas sensor device. The third way altitude is determined is from a post-processed modeled altitude from a barometer pressure measurement and thermistor temperature measurement. The stationary anemometer altitude may be from a fixed number that is a-priori measured in the field at the time of setup.

The system 500 may include a first wind model component 506. The first wind model component 506 may be generated based on an initial parameter guess 502 and a first stationary anemometer or third-party meteorological data service providing information 504. The anemometer may be field deployable hardware. The third-party meteorological data may be generated by, received by, and/or stored on a server. Data from the anemometer may be streamed from the anemometer over a wireless link to a tablet, laptop, computer, or the like and then the data may be processed on a computer or server. In other embodiments, the data from the anemometer may be stored locally and uploaded. The system may also include an optimizing algorithm component 510 based on the first wind model component 506 and a second stationary anemometer, aerial-based data from an onboard anemometer, control-system derived wind vector during a flight of an unmanned aerial vehicle (UAV), and/or a third-party meteorological data service 508. The anemometer may be a field deployable hardware. The third-party meteorological data may be generated by, received by, and/or stored on a server. Data from the anemometer may stream from the anemometer over a wireless link to a tablet, laptop, computer, or the like and then the data may be processed on a computer or server. In other embodiments, the data may be stored locally and uploaded. A control-system derived wind vector can be computed onboard the UAV through the autopilot or post processed on a computer or server. The optimizing algorithm component 510 may run on a computing device, such as a server.

The system 500 may also include a second wind model component 512 based on the optimizing algorithm component 510 and the first stationary anemometer or third-party meteorological data service providing information 504.

The system 500 may also include a flux calculation component 516 based on the second wind model component 512 and a concentration and position data component 514. The concentration and position data component 514 may be from a trace gas sensor and a positional unit, such as a GPS unit. In some embodiments, the trace gas sensor and positional unit may be in a same device. In other embodiments, the trace gas sensor and positional unit may be co-located. In one embodiment, said solutions refer to the surface roughness value, stability classification scalar, etc. that may be optimized for, and are used to put back into the wind model. As shown in FIG. 5A, in one example the solution is the output from the optimizing algorithm 510, put back into the second wind model 512.

FIG. 5B depicts a high-level block diagram of an alternate system 501 for correcting wind data, according to one embodiment. The system 501 may include one or more of: a first stationary anemometer 518, a second stationary anemometer 521, a third-party meteorological data service 520, an unmanned aerial vehicle (UAV) 522, and a processor 536.

The first stationary anemometer 518 and/or second stationary anemometer 521 may be field deployable hardware. The first stationary anemometer 518 and/or second stationary anemometer 521 altitude may each be a fixed number that are a-priori measured in the field at the time of setup. The third-party meteorological data service 520 may be data sent from a third-party and processed on the processor 536.

The UAV 522 may include one or more of: a control system 524, a GPS 526, a trace gas sensor 528, a LIDAR sensor 530, a barometer sensor 532, a thermistor sensor 534, and/or an anemometer. In some embodiments, the one or more components of the UAV 522 may be a part of the onboard control system 524 and/or the trace gas sensor 528. The control system 524 may include a processor, software/firmware including instructions stored in memory, configured to execute and perform one or more of the functions described herein.

The processor 536 may include one or more of: an initial parameter component 538, a first wind data component 540, a first wind model component 542, a second wind data component 544, a second wind model component 546, an optimizing algorithm component 548, a concentration and position data component 550, and a flux calculation component 552. In some embodiments, the processor 536 may be a server having addressable memory. In other embodiments, the processor 536 may be part of a ground control system (GCS) in communication with the UAV 522. In other embodiments, the processor 536 may be a part of the UAV 522. The initial parameter component 538 may be used to generate the initial parameter guess (502, FIG. 5A).

The first wind data component 540 may determine and/or store first wind data including wind speed and wind direction from the first stationary anemometer 518 and/or the third-party meteorological data service 520. The first wind data component 540 may be used to determine and/or store data from the first stationary anemometer and/or meteorological data service (504, FIG. 5A). The first wind data component 540 may receive streamed data from the first stationary anemometer 518 and/or the third-party meteorological data service 520 over a wireless link to be processed. Once processed, the first wind data may be stored locally and/or uploaded. The first wind model component 542 may be used to generate the first wind model (506, FIG. 5A).

The second wind data component 544 may be used to determine and/or store data from the second stationary anemometer 521, aerial-based data from an onboard anemometer 535, control-system 524 derived wind vector during a flight of an unmanned aerial vehicle (UAV) 522, and/or a third-party meteorological data service 520 (508, FIG. 5A). The second wind data component 544 may receive streamed data from the second stationary anemometer 521, the third-party meteorological data service 520, onboard control system 524 of the UAV 522, and/or an anemometer 535 disposed onboard the UAV 522 over a wireless link to be processed. Once processed, the second wind data may be stored locally and/or uploaded. The second wind model component 546 may be used to generate the second wind model component (512, FIG. 5A).

The optimizing algorithm component 548 may be used to process the optimizing algorithm component (510, FIG. 5A).

The concentration and position data component 550 may generate trace gas data from a trace gas sensor 528 and/or a GPS 526 of the UAV 522. In some embodiments, the GPS 526 may be a positional sensor. In some embodiments, the trace gas sensor 528 and GPS 526 may be part of a same device. In other embodiments, the trace gas sensor 528 and GPS 526 may be collocated. The trace gas sensor 528 generates trace gas data relating to a concentration of trace gas present at a corresponding location determined by the GPS 526 or other position sensor. The concentration and position data component 550 may generate, process, and/or store this trace gas data including trace gas concentration and location. The concentration and position data component 550 may be used to process the concentration and position component (514, FIG. 5A).

The flux calculation component 552 may be used to receive, process, and/or store the flux calculation component (516, FIG. 5A). The flux calculation component 516 may be used to determine a trace gas leak from a trace gas equipment source based on the received trace gas measurements, the generated first wind model, and the generated second wind model.

FIG. 5C depicts a high-level block diagram of another alternate system 503 for correcting wind data, according to one embodiment. The components of FIG. 5C are shown and described in FIG. 5B. In the embodiment shown in FIG. 5C, the UAV 522 may include a control system 524, GPS 526 or other collocated position sensor, and a trace gas sensor 528.

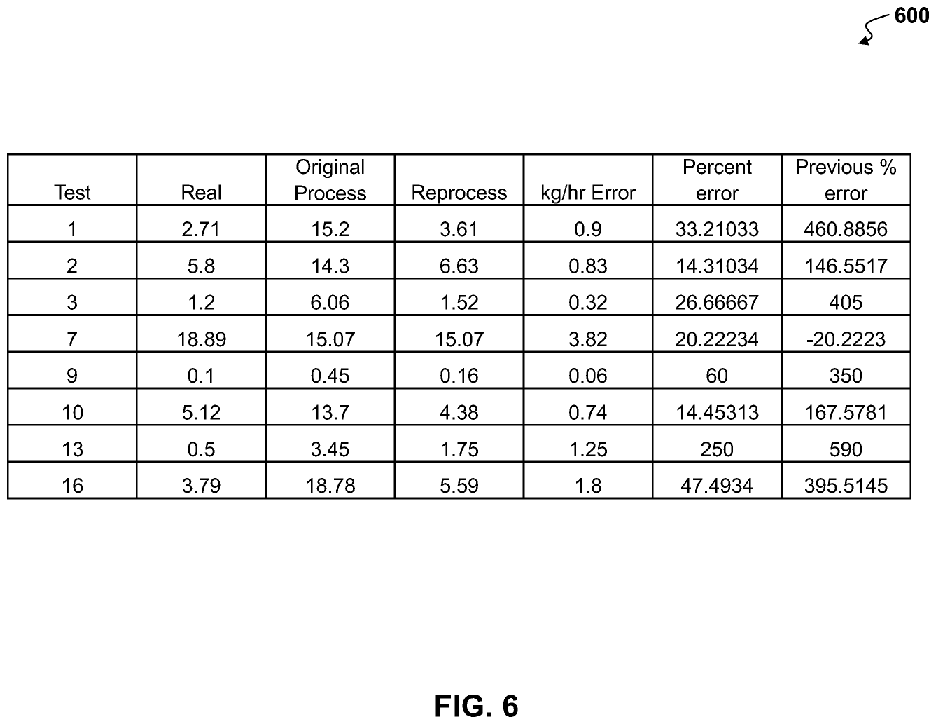

FIG. 6 depicts a table 600 of processed and reprocessed results for trace gas using the disclosed method, according to one embodiment. Using the disclosed method and system, with a more accurate wind profile, as determined manually or via automated processing, processed emission rates that are closer to the true emission rates when conducting a controlled release test such as shown in FIG. 6. The tests shown in the FIG. 6 table 600 for reprocessing are “single release” tests where only one “node”, e.g., release source, was active.

Using the disclosed method and system, the average percent error is reduced. It is noted that the greatest errors occur on smaller releases. Using this method, a reprocessed total emission rate of 38.71 kg/hr was detected compared to the known released total of 38.11 kg/hr resulting in a relative error of 1.57%. However, this does not account for the +/− values of errors and by adding them the error is diminished. Using the absolute value of errors, above or below the real release rate, this disclosed system and method resulted in a total error of 9.72 kg/hr over the tests. This yields an error of 25.5% over the 8 test flights that have been reprocessed. Errors less than or equal to 30% are the currently accepted threshold for a successful survey.

The disclosed system and method allow for measurement and quantification of leaks of trace gases in areas with large or complex structures without the need for multiple wind sensors or anemometers and without the need for long set up and/or tear down times.

In some embodiments, the disclosed system and method may use expert judgement to decide when the wind model is “well fitted” to the point of satisfaction. In other embodiments, the disclosed system and method may determine when the wind model is “well fitted”. In other embodiments, the disclosed system and method is provided a threshold (e.g., error value, derivative of error, etc.) for convergence to determine when the wind model has achieved the “best fit”.

In some embodiments, the wind may be shown as an average on each of the altitude ranges. In some embodiments, especially between large structures, there may be eddies, swirling, and/or wind funneling that impact wind speed and direction throughout the flow field. The disclosed system and method may account for these wind effects.

In some embodiments, specific information about the wind direction and speed may be determined at any point in said model. In some embodiments, speed and/or direction at altitude or even an average to compare to third-party data would allow the user to not have to manually project the two vectors, the users and a third-party, to Normal of the plane, direction relative to north. Orientation of the flux plane is relative to N.

In some embodiments, the wind model may be stored remotely to allow users to access the information remotely.

Averaging speed and/or direction of the wind measurements may be used in some embodiments. In some embodiments, the model may be altitude dependent or an average of a 1d Model, speed at height and direction at height. The disclosed system and method may limit the averaging based on the individual square or even quadrant of the survey area.

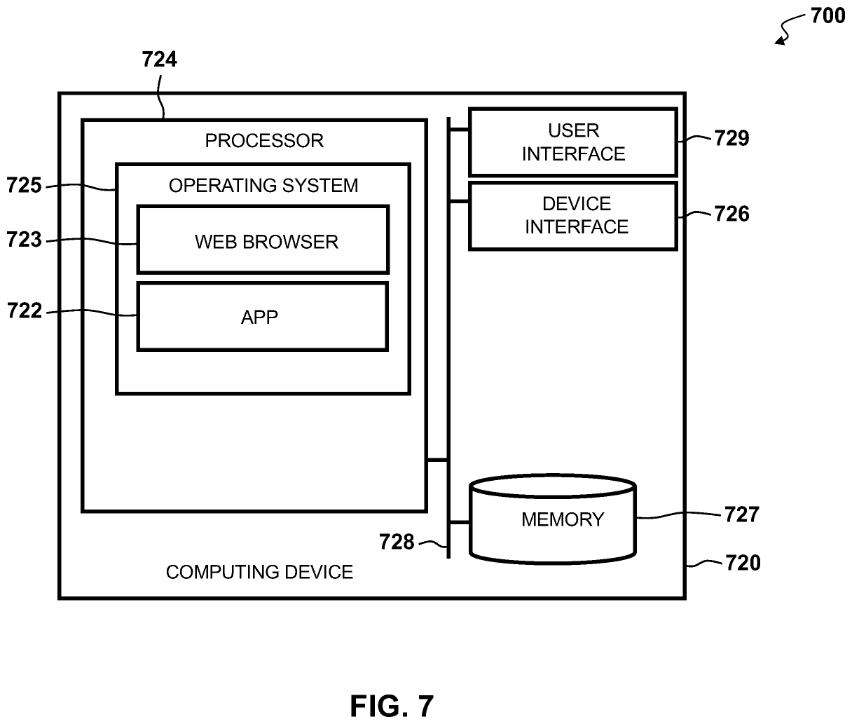

FIG. 7 illustrates an example of a top-level functional block diagram of a computing device embodiment 700. The example operating environment is shown as a computing device 720 comprising a processor 724, such as a central processing unit (CPU), addressable memory 727, an external device interface 726, e.g., an optional universal serial bus port and related processing, and/or an Ethernet port and related processing, and an optional user interface 729, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 728. In some embodiments, via an operating system 725 such as one supporting a web browser 723 and applications 722, the processor 724 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

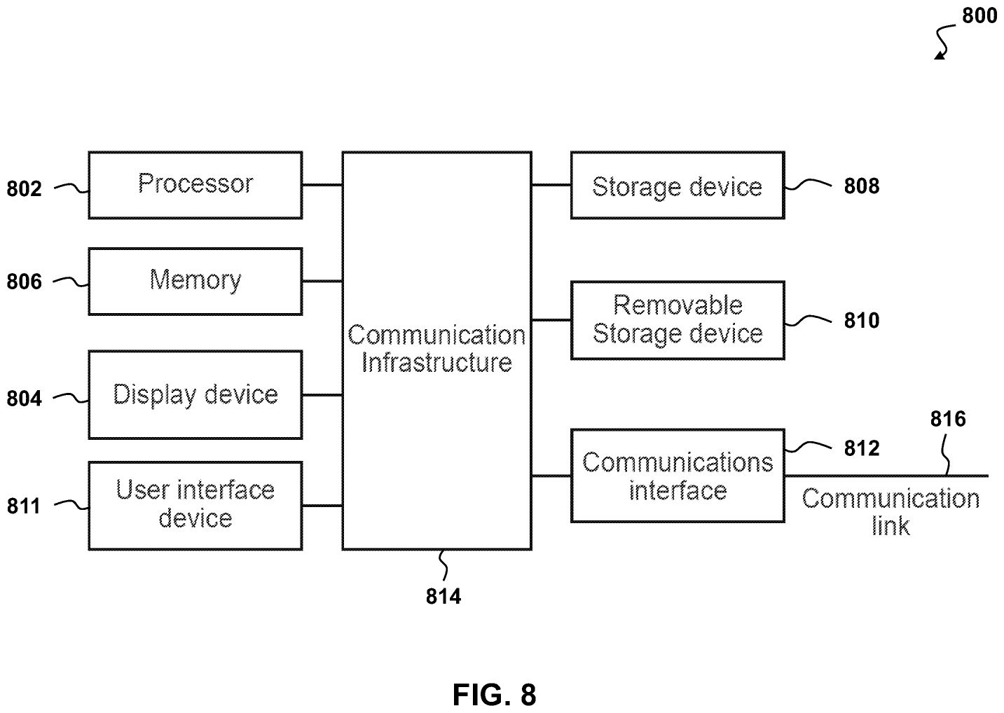

FIG. 8 is a high-level block diagram 800 showing a computing system comprising a computer system useful for implementing an embodiment of the system and process, disclosed herein. Embodiments of the system may be implemented in different computing environments. The computer system includes one or more processors 802, and can further include an electronic display device 804 (e.g., for displaying graphics, text, and other data), a main memory 806 (e.g., random access memory (RAM)), storage device 808, a removable storage device 810 (e.g., removable storage drive, a removable memory module, a magnetic tape drive, an optical disk drive, a computer readable medium having stored therein computer software and/or data), user interface device 811 (e.g., keyboard, touch screen, keypad, pointing device), and a communication interface 812 (e.g., modem, a network interface (such as an Ethernet card), a communications port, or a PCMCIA slot and card). The communication interface 812 allows software and data to be transferred between the computer system and external devices. The system further includes a communications infrastructure 814 (e.g., a communications bus, cross-over bar, or network) to which the aforementioned devices/modules are connected as shown.

Information transferred via communications interface 814 may be in the form of signals such as electronic, electromagnetic, optical, or other signals capable of being received by communications interface 814, via a communication link 816 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 812. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

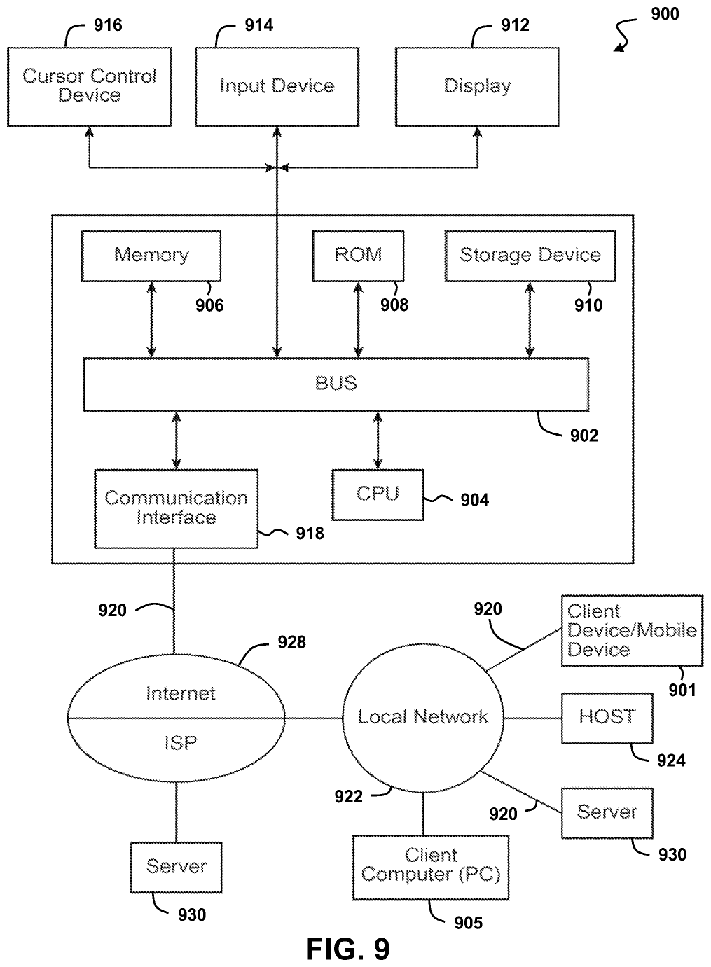

FIG. 9 shows a block diagram of an example system 900 in which an embodiment may be implemented. The system 900 includes one or more client devices 901 such as consumer electronics devices, connected to one or more server computing systems 930. A server 930 includes a bus 902 or other communication mechanism for communicating information, and a processor (CPU) 904 coupled with the bus 902 for processing information. The server 930 also includes a main memory 906, such as a random access memory (RAM) or other dynamic storage device, coupled to the bus 902 for storing information and instructions to be executed by the processor 904. The main memory 906 also may be used for storing temporary variables or other intermediate information during execution or instructions to be executed by the processor 904. The server computer system 930 further includes a read only memory (ROM) 908 or other static storage device coupled to the bus 902 for storing static information and instructions for the processor 904. A storage device 910, such as a magnetic disk or optical disk, is provided and coupled to the bus 902 for storing information and instructions. The bus 902 may contain, for example, thirty-two address lines for addressing video memory or main memory 906. The bus 902 can also include, for example, a 32-bit data bus for transferring data between and among the components, such as the CPU 904, the main memory 906, video memory and the storage 910. Alternatively, multiplex data/address lines may be used instead of separate data and address lines.

The server 930 may be coupled via the bus 902 to a display 912 for displaying information to a computer user. An input device 914, including alphanumeric and other keys, is coupled to the bus 902 for communicating information and command selections to the processor 904. Another type or user input device comprises cursor control 916, such as a mouse, a trackball, or cursor direction keys for communicating direction information and command selections to the processor 904 and for controlling cursor movement on the display 912.

According to one embodiment, the functions are performed by the processor 904 executing one or more sequences of one or more instructions contained in the main memory 906. Such instructions may be read into the main memory 906 from another computer-readable medium, such as the storage device 910. Execution of the sequences of instructions contained in the main memory 906 causes the processor 904 to perform the process steps described herein. One or more processors in a multi-processing arrangement may also be employed to execute the sequences of instructions contained in the main memory 906. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 904 for execution. Such a medium may take many forms, including but not limited to, non-volatile media, volatile media, and transmission media. Non-volatile media includes, for example, optical or magnetic disks, such as the storage device 910. Volatile media includes dynamic memory, such as the main memory 906. Transmission media includes coaxial cables, copper wire and fiber optics, including the wires that comprise the bus 902. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 904 for execution. For example, the instructions may initially be carried on a magnetic disk of a remote computer. The remote computer can load the instructions into its dynamic memory and send the instructions over a telephone line using a modem. A modem local to the server 930 can receive the data on the telephone line and use an infrared transmitter to convert the data to an infrared signal. An infrared detector coupled to the bus 902 can receive the data carried in the infrared signal and place the data on the bus 902. The bus 902 carries the data to the main memory 906, from which the processor 904 retrieves and executes the instructions. The instructions received from the main memory 906 may optionally be stored on the storage device 910 either before or after execution by the processor 904.

The server 930 also includes a communication interface 918 coupled to the bus 902. The communication interface 918 provides a two-way data communication coupling to a network link 920 that is connected to the world wide packet data communication network now commonly referred to as the Internet 928. The Internet 928 uses electrical, electromagnetic or optical signals that carry digital data streams. The signals through the various networks and the signals on the network link 920 and through the communication interface 918, which carry the digital data to and from the server 930, are exemplary forms or carrier waves transporting the information.

In another embodiment of the server 930, interface 918 is connected to a network 922 via a communication link 920. For example, the communication interface 918 may be an integrated services digital network (ISDN) card or a modem to provide a data communication connection to a corresponding type of telephone line, which can comprise part of the network link 920. As another example, the communication interface 918 may be a local area network (LAN) card to provide a data communication connection to a compatible LAN. Wireless links may also be implemented. In any such implementation, the communication interface 918 sends and receives electrical electromagnetic or optical signals that carry digital data streams representing various types of information.

The network link 920 typically provides data communication through one or more networks to other data devices. For example, the network link 920 may provide a connection through the local network 922 to a host computer 924 or to data equipment operated by an Internet Service Provider (ISP). The ISP in turn provides data communication services through the Internet 928. The local network 922 and the Internet 928 both use electrical, electromagnetic or optical signals that carry digital data streams. The signals through the various networks and the signals on the network link 920 and through the communication interface 918, which carry the digital data to and from the server 930, are exemplary forms or carrier waves transporting the information.

The server 930 can send/receive messages and data, including e-mail, program code, through the network, the network link 920 and the communication interface 918. Further, the communication interface 918 can comprise a USB/Tuner and the network link 920 may be an antenna or cable for connecting the server 930 to a cable provider, satellite provider or other terrestrial transmission system for receiving messages, data and program code from another source.

The example versions of the embodiments described herein may be implemented as logical operations in a distributed processing system such as the system 900 including the servers 930. The logical operations of the embodiments may be implemented as a sequence of steps executing in the server 930, and as interconnected machine modules within the system 900. The implementation is a matter of choice and can depend on performance of the system 900 implementing the embodiments. As such, the logical operations constituting said example versions of the embodiments are referred to for e.g., as operations, steps, or modules.

Similar to a server 930 described above, a client device 901 can include a processor, memory, storage device, display, input device and communication interface (e.g., e-mail interface) for connecting the client device to the Internet 928, the ISP, or LAN 922, for communication with the servers 930.

The system 900 can further include computers (e.g., personal computers, computing nodes) 905 operating in the same manner as client devices 901, where a user can utilize one or more computers 905 to manage data in the server 930.

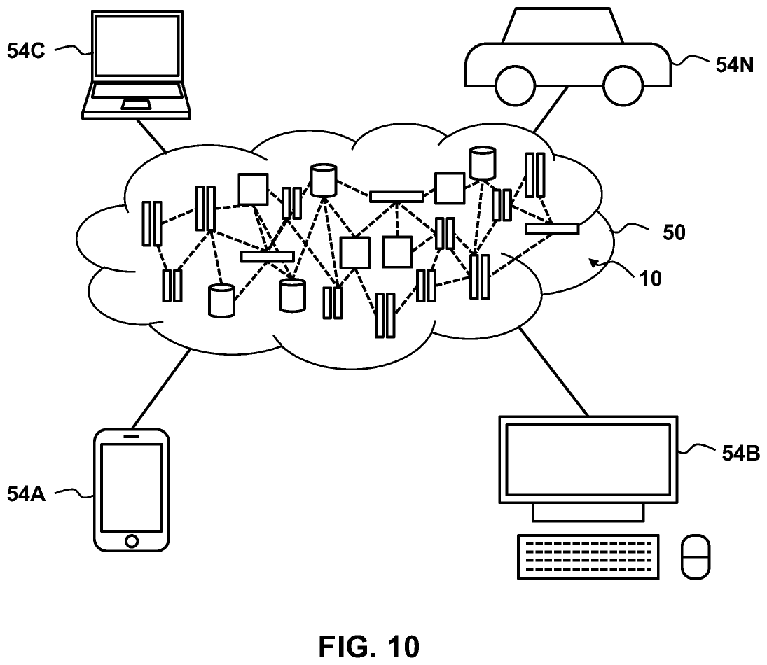

Referring now to FIG. 10, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or UAV system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

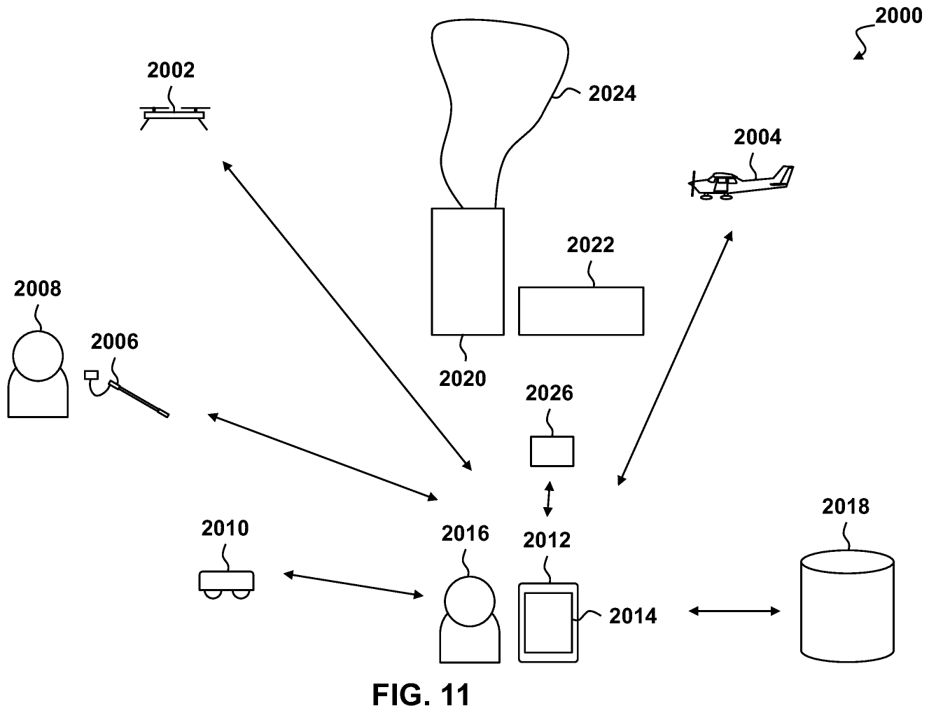

FIG. 11 depicts a system 2000 for detecting trace gases, according to one embodiment. The system may include one or more trace gas sensors located in one or more vehicles 2002, 2004, 2006, 2010. The one or more trace gas sensors may detect elevated trace gas concentrations from one or more potential gas sources 2020, 2022, such as a holding tank, pipeline, or the like. The potential gas sources 2020, 2022 may be part of a large facility, a small facility, or any location. The potential gas sources 2020, 2022 may be clustered and/or disposed distal from one another. The one or more trace gas sensors may be used to detect and quantify leaks of toxic gases, e.g., hydrogen disulfide, or environmentally damaging gases, e.g., methane, sulfur dioxide) in a variety of industrial and environmental contexts. Detection and quantification of these leaks are of interest to a variety of industrial operations, such as oil and gas, chemical production, and painting. Detection and quantification of leaks is also of value to environmental regulators for assessing compliance and for mitigating environmental and safety risks. In some embodiments, the at least one trace gas sensor may be configured to detect methane. In other embodiments, the at least one trace gas sensor may be configured to detect sulfur oxide, such as SO, SO2, SO3, S7O2, S6O2, S2O2, and the like. A trace gas leak 2024 may be present in a potential gas source 2020. The one or more trace gas sensors may be used to identify the trace gas leak 2024 and/or the source 2020 of the trace gas leak 2024 so that corrective action may be taken.

The one or more vehicles 2002, 2004, 2006, 2010 may include an unmanned aerial vehicle (UAV) 2002, an aerial vehicle 2004, a handheld device 2006, and a ground vehicle 2010. In some embodiments, the UAV 2002 may be a quadcopter or other device capable of hovering, making sharp turns, and the like. In other embodiments, the UAV 2002 may be a winged aerial vehicle capable of extended flight time between missions. The UAV 2002 may be autonomous or semi-autonomous in some embodiments. In other embodiments, the UAV 2002 may be manually controlled by a user. The aerial vehicle 2004 may be a manned vehicle in some embodiments. The handheld device 2006 may be any device having one or more trace gas sensors operated by a user 2008. In one embodiment, the handheld device 2006 may have an extension for keeping the one or more trace gas sensors at a distance from the user 2008. The ground vehicle 2010 may have wheels, tracks, and/or treads in one embodiment. In other embodiments, the ground vehicle 2010 may be a legged robot. In some embodiments, the ground vehicle 2010 may be used as a base station for one or more UAVs 2002. In some embodiments, one or more aerial devices, such as the UAV 2002, a balloon, or the like, may be tethered to the ground vehicle 2010. In some embodiments, one or more trace gas sensors may be located in one or more stationary monitoring devices 2026. The one or more stationary monitoring devices may be located proximate one or more potential gas sources 2020, 2022. In some embodiments, the one or more stationary monitoring devices may be relocated.

The one or more vehicles 2002, 2004, 2006, 2010 and/or stationary monitoring devices 2026 may transmit data including trace gas data to a ground control station (GCS) 2012. The GCS may include a display 2014 for displaying the trace gas concentrations to a GCS user 2016. The GCS user 2016 may be able to take corrective action if a gas leak 2024 is detected, such as by ordering a repair of the source 2020 of the trace gas leak. The GCS user 2016 may be able to control movement of the one or more vehicles 2002, 2004, 2006, 2010 in order to confirm a presence of a trace gas leak in some embodiments.

In some embodiments, the GCS 2012 may transmit data to a cloud server 2018. In some embodiments, the cloud server 2018 may perform additional processing on the data. In some embodiments, the cloud server 2018 may provide third party data to the GCS 2012, such as wind speed, temperature, pressure, weather data, or the like.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. A method comprising:
generating a first wind model, wherein the first wind model is based on at least one or more key parameters;
generating a second wind model, wherein the second wind model is an altitude-based wind model generated by refining the first wind model based on a secondary wind measurement device from an aerial-based data from an onboard anemometer;
adjusting the second wind model based on a comparison of two or more altitudes; and
adjusting the one or more key parameters to achieve a solution convergence to determine the second wind model, wherein the solution convergence is achieved when at least one of: a determined error between a received wind data and the second wind model is minimized to within an accepted tolerance range and a number of minimization attempts exceeds a threshold.

2. The method of claim 1, wherein the one or more key parameters comprise a surface roughness value.

3. The method of claim 1, wherein the one or more key parameters comprise a stability value.

4. The method of claim 1, wherein the one or more key parameters comprise a displacement height value.

5. The method of claim 1, further comprising:
determining a presence of one or more trace gases using a determined wind model.

6. The method of claim 3, further comprising:
quantifying the presence of the one or more trace gases using a determined wind model.

7. The method of claim 3, further comprising:
determining a flow field using two or more UAV-based wind measurements.

8. The method of claim 1, wherein a UAV-based data comprises one or more of: a throttle response, a pitch, a roll, and a yaw.

9. The method of claim 1, wherein the two or more altitudes comprise one or more of: a real anemometer altitude, an altitude where highest concentrations of trace gas are measured, a building height, and an estimated building height.

10. The method of claim 1, wherein the two or more altitudes comprise one or more of: a real anemometer altitude, an altitude where a highest concentration of trace gas is measured, a building height, an estimated building height, and a displacement height.

11. The method of claim 1, wherein the determined error between the received wind data and the second wind model is a least square residual error.

12. The method of claim 1, wherein a wind speed measured by the secondary wind measurement device is at least one of: higher than an actual wind speed and lower than the actual wind speed.

13. The method of claim 12, wherein the one or more key parameters are adjusted based on the wind speed measured by the secondary wind measurement device.

14. A system comprising:
a first stationary anemometer configured to generate wind data;
a second stationary anemometer configured to generate wind data;
a third-party meteorological data service configured to provide wind data;
an unmanned aerial (UAV) vehicle, wherein the UAV comprises one or more of: a control system, a global positioning sensor (GPS), a trace gas sensor, a LIDAR sensor, a barometer sensor, a thermistor sensor, and an anemometer;
a processor in communication with one or more of: the first stationary anemometer, the second stationary anemometer, the third-party meteorological data service, and the unmanned aerial vehicle (UAV), wherein the processor is configured to:
determine, by an initial parameter component, an initial parameter guess;
determine, by a first wind data component, a first wind data from at least one of: the first stationary anemometer and the third-party meteorological data service;
generate, by a first wind model component, a first wind model based on the determined initial parameter component and the determined first wind data;
determine, by a second wind data component, a second wind data from the anemometer;
process, by an optimizing algorithm component, the generated first wind model via an optimizing algorithm;
generate, by a second wind model component, a second wind model based on one or more of: the optimizing algorithm and the first wind data;
generate, by the concentration and position data component, a trace gas data from data from the trace gas sensor and the GPS of the UAV; and
determine, by the flux calculation component, an elevated trace gas concentration based on the generated trace gas data and the second wind model.

15. The system of claim 14, wherein a wind speed measured by the anemometer is at least one of: higher than an actual wind speed and lower than the actual wind speed.

16. The system of claim 15, wherein the second wind model component is generated based on the wind speed measured by the secondary wind measurement device.
